(19) United States
(12) Patent Application Publication
(10) Pub. No.: US 2014/0330746 A1
(43) Pub. Date: Nov. 6, 2014

(54) STOCHASTIC INVESTMENT PLANNING SYSTEM

(71) Applicant: INTERNATIONAL BUSINESS MACHINES CORPORATION, Armonk, NY (US)

(72) Inventors: Mehmet F. Candas, Croton On Hudson, NY (US); Arun Hampapur, Norwalk, CT (US); Tarun Kumar, Mohegan Lake, NY (US); Shilpa N. Mahatma, Mohegan Lake, NY (US)

(73) Assignee: International Business Machines Corporation, Armonk, NY (US)

(21) Appl. No.: 13/874,609

(22) Filed: May 1, 2013

(51) Int. Cl. G06Q 40/00

(52) U.S. Cl. CPC G06Q 40/06
USPC 705/36 R

(57) ABSTRACT

Embodiments relate to stochastic investment planning. One aspect includes receiving a plurality of constraints associated with projects to be performed by a plurality of agencies. The constraints are compared across the projects to identify projects having a spatial overlap and compatible project types. Two or more of the projects are combined based on compatibility of the projects having the spatial overlap. An optimization model is applied to the combined projects to produce an optimization parameter representing a critical attribute based on at least one uncertainty of the combined projects. The comparing, the combining, and the applying of the optimization model are iteratively repeated while varying a threshold for combining the projects until the optimization parameter is determined to be within an acceptable range.

### BACKGROUND

The present invention relates generally to planning systems, and more specifically, to stochastic investment planning for multi-agency capital projects.

Investment planning for a city agency is a complex process. Given budget shortfalls, cities need to identify the right investment strategies while considering available financial resources, political drivers, sustainability needs, and public perception. Budget planning for municipal infrastructure can include short term planning (e.g., 1-5 years) and long term planning (e.g., 5-50 years). In addition to planning complexity for individual agencies, a city needs to ensure that the agencies collaborate with each other to prevent rework, such as digging the same street twice.

A cross section of a typical city block includes a number of infrastructure elements such as gutters, sewer, telephone cables, television cables, electricity cables, gas lines, water lines, roadway surface, sidewalks, and the like. Accordingly, a number of agencies and companies, such as a road department, water works, sewage and storm department, electric utility, gas utility, telephone, and cable television companies, have an ownership stake in installing and maintaining their respective assets. To best utilize resources when installing or upgrading infrastructure, a number of drivers that influence investment planning decisions should be considered; however, the drivers are difficult to quantify as the drivers and their relative importance can shift over time. Managing individual projects with time and budget constraints can be a challenging task itself, and the challenge is multiplied when considering multiple projects executed over varying time spans.

### BRIEF SUMMARY

An embodiment is a computer-implemented method for stochastic investment planning. The method includes receiving a plurality of constraints associated with projects to be performed by a plurality of agencies. The constraints are compared across the projects to identify projects having a spatial overlap and compatible project types. Two or more of the projects are combined based on compatibility of the projects having the spatial overlap. An optimization model is applied to the combined projects to produce an optimization parameter representing a critical attribute based on at least one uncertainty of the combined projects. The comparing, the combining, and the applying of the optimization model are iteratively repeated while varying a threshold for combining the projects until the optimization parameter is determined to be within an acceptable range.

Another embodiment is a computer program product for stochastic investment planning. The computer program product includes a computer readable storage medium having computer readable program code embodied therewith, said program code being executable by a processor to perform a method. The method includes receiving a plurality of constraints associated with projects to be performed by a plurality of agencies. The constraints are compared across the projects to identify projects having a spatial overlap and compatible project types. Two or more of the projects are combined based on compatibility of the projects having the spatial overlap. An optimization model is applied to the combined projects to produce an optimization parameter representing a critical attribute based on at least one uncertainty of the combined projects. The comparing, the combining, and the applying of the optimization model are iteratively repeated while varying a threshold for combining the projects until the optimization parameter is determined to be within an acceptable range.

A further embodiment is a system for stochastic investment planning. The system includes a processor and an investment planning tool executable by the processor to perform a method. The method includes receiving a plurality of constraints associated with projects to be performed by a plurality of agencies. The constraints are compared across the projects to identify projects having a spatial overlap and compatible project types. Two or more of the projects are combined based on compatibility of the projects having the spatial overlap. An optimization model is applied to the combined projects to produce an optimization parameter representing a critical attribute based on at least one uncertainty of the combined projects. The comparing, the combining, and the applying of the optimization model are iteratively repeated while varying a threshold for combining the projects until the optimization parameter is determined to be within an acceptable range.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts an example of drivers that influence investment planning decisions;

FIG. 2A depicts an example of a budgeting and bucketing process in accordance with an embodiment;

FIG. 2B depicts further details of the budgeting and bucketing process in accordance with an embodiment;

FIG. 3 depicts a user interface of a stochastic investment planning system in accordance with an embodiment;

FIG. 4 depicts a layered map view of a stochastic investment planning system in accordance with an embodiment;

FIG. 5 depicts a process for stochastic investment planning in accordance with an embodiment; and

FIG. 6 depicts a computer system for stochastic investment planning in accordance with an embodiment.

### DETAILED DESCRIPTION

Embodiments described herein include a stochastic investment planning system for multi-agency capital projects. Investment planning enables a planning department to perform scenario analysis to identify the right set of projects at the right time for installing and upgrading infrastructure. This is enabled using an optimization model to assist in selecting a set of projects to be performed at particular times to maximize return on investment.

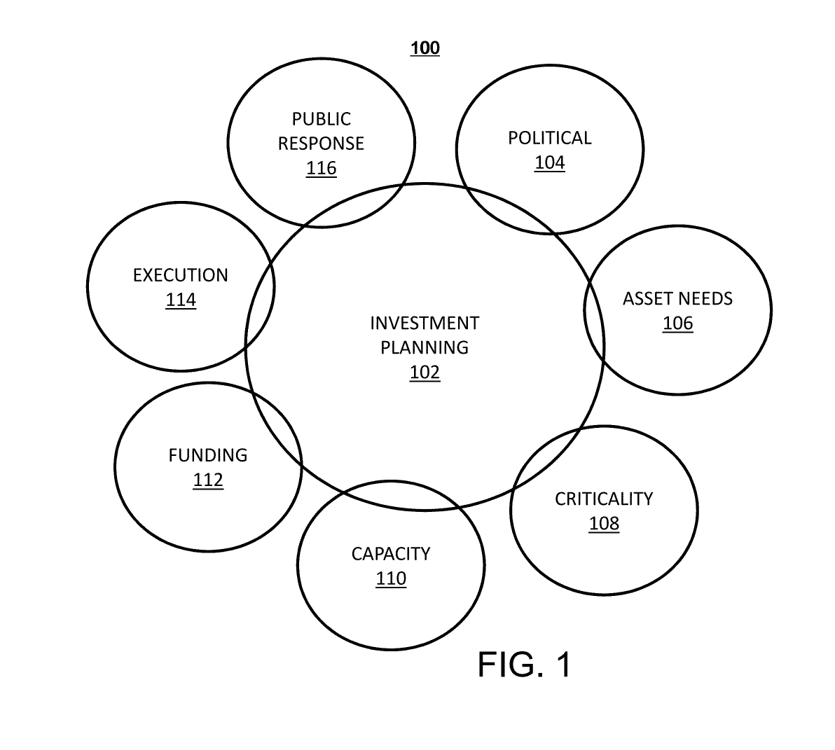

FIG. 1 depicts an example of drivers that influence investment planning decisions that are considered in accordance with embodiments. Driver model 100 graphically depicts various drivers to an investment planning model 102. The investment planning model 102 considers operations, management, and capital impacts of political factors 104, asset needs 106, criticality factors 108, capacity factors 110, funding factors 112, execution factors 114, and public response factors 116. Political factors 104 can include a need for even distribution, preferential projects, and dealing with citizen complaints. Asset needs 106 can include asset performance, and past/future expected failures. Criticality factors 108 can include critical infrastructure, such as city center and hospitals, congestion on highways and main streets, and disaster recovery. Capacity factors 110 can include new development and infill development where single family homes are replaced by apartment complexes. Funding factors 112 can include agency capital funding, taxes, state/province funding, and federal/national funding. Execution factors 114 can include local execution capacity and mixing of projects of different sizes, such as varying orders of budget magnitude per project. Public response factors 116 can include objections to sidewalks and special requirements, such as maintaining heritage looks.

Exemplary embodiments enable definition of the driver model 100 and configuration of weighting associated with various factors 104-116 to optimize investment and timing. Factors that are difficult to quantify due to time varying nature, such as asset needs 106, funding factors 112, and capacity 110, may be defined stochastically. Stochastic definitions can change for different project lifespans considered when combining and sequencing projects.

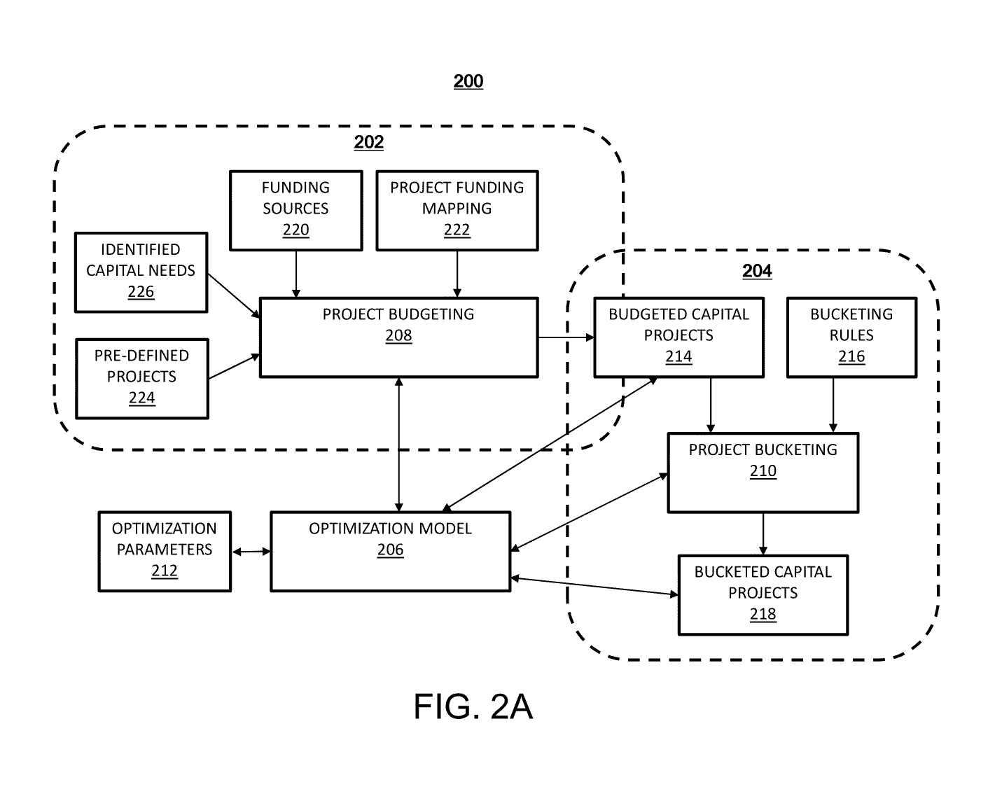

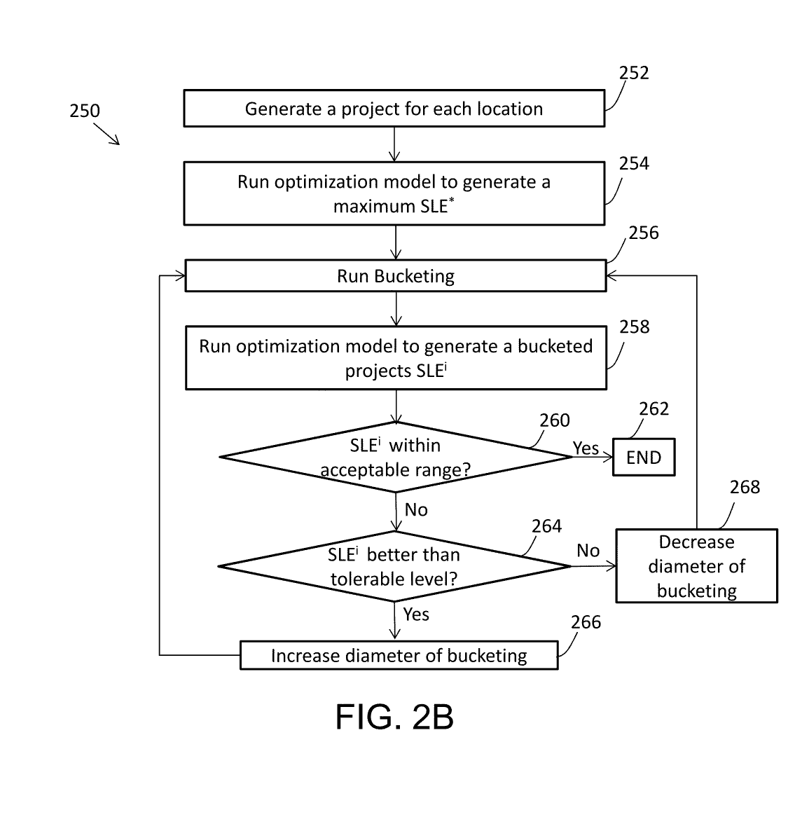

FIG. 2A depicts an example of a budgeting and bucketing process in accordance with an embodiment. An investment planning process 200 includes a budgeting process 202 that overlaps with a bucketing process 204. An optimization model 206 can be used in conjunction with project budgeting logic 208 of the budgeting process 202 and project bucketing logic 210 of the bucketing process 204. A number of optimization parameters 212 can be used and updated by the optimization model 206 to define iterative factors to optimize the budgeting process 202 and the bucketing process 204 towards optimized solutions. The investment planning process 200 is an iterative process where project budgeting factors are considered by the project budgeting logic 208 to create budgeted capital projects 214, which are then fed with bucketing rules 216 to the project bucketing logic 210 to create bucketed capital projects 218. Examples of budgeting factors include funding sources 220, project funding mapping 222, pre-defined projects 224, and identified capital needs 226.

The funding sources 220 can be derived from the funding factors 112 of FIG. 1, that define sources of revenue, such as particular taxes, higher-level provided funding from state/federal government, reserves, special assessments, and the like. The project funding mapping 222 identifies funding mapping based on different dimensions of projects including the pre-defined projects 224. Projects can be defined over multiple locations and contain multiple assets. For example, each project can include work done on multiple road segments (e.g., from intersection to intersection) and include multiple individual units of assets such as road pavement or water pipes. The budgeting process 202 to create budgeted capital projects 214 may be used to define parameters of base level projects that can be further combined and grouped by the bucketing process 204 to create the bucketed capital projects 218. Data from the bucketed capital projects 218 can be fed back into the project budgeting logic 208 for further iterations. The optimization model 206 can also apply constraints of the project budgeting logic 208 and the project bucketing logic 210 as part of iterating toward an optimized solution. The investment planning process 200 can be performed to cover multi-year investment planning with an optimization goal of maximizing the service life extension associated with the underlying resources.

In an exemplary embodiment, the investment planning process 200 seeks to maximize the remaining service life and performance drivers subject to total funding, funding by project types, funding by asset classes, funding by performance drivers, funding prioritization, minimum service life extension expected, critical project requirements, equitable ward/political boundary distribution (i.e., spatial correlation), multi-block level assessment (i.e., spatial proximity), and grouping of similar prescription on each block segment (i.e., spatial overlap). Stochastic optimization performed by the optimization model 206 can seek to perform optimization for a number of scenarios. Scenarios can be defined at multiple levels. For example, execution scenarios are scenarios that are defined by selecting budgeting and bucketing parameters. Stochastic programming scenarios are scenarios that are created within the optimization model 206 that further expand a number of possible combinations. For instance, a single execution scenario that includes multiple assets that have defined levels of uncertainty can result in multiple stochastic programming scenarios that consider each of the possible combinations.

To optimize the investment planning process 200, the bucketing process 204 defines groups of locations (buckets) by considering project compatibility and spatial distance (such as full replacement projects at the streets next to each other). Spatial distance can be defined using a variety of definitions such as “crow” distance (straight line), road network distance, or travel time. Bucketing can generate compatible sizes of projects to align with different sizes of local contractor companies and enable more efficient execution for the contractor companies. Instead of working at different far away locations, the contractors will be working at close proximity. Bucketing also enables more efficient execution for traffic control (i.e., impact on public) and combines multiple locations such that traffic does not encounter multiple differences in road condition. For instance, if one section of a road is new and a neighboring section is old, this could result in accidents/traffic congestion due to sudden changes in speed as vehicles transition between sections. For a given iteration of bucketing, it is possible that some projects can lack funding based on allocation to other projects, and service life extension can vary based on grouping of locations that may have different levels of criticality/asset health scores. To provide a sufficient level of bucketing, the investment planning process 200 is run iteratively.

FIG. 2B depicts a process 250 for iterative execution of the investment planning process 200 of FIG. 2A. At block 252, a project is generated for each location using the budgeting process 202 of FIG. 2A to form the budgeted capital projects 214 of FIG. 2A. The project funding mapping 222 and/or pre-defined projects 224 of FIG. 2A can define a distance matrix between each project location in addition to a project location list and project types to check for compatibility. For each project location a unique project is generated. At block 254, the optimization model 206 of FIG. 2A is run to generate a maximum service life extension, referred to as SLE*, for the identified projects. Having an individual project for each location enables maximum flexibility in investment planning process 200 of FIG. 2A.

At block 256, project bucketing 210 of FIG. 2A is performed by the bucketing process 204 of FIG. 2A to identify projects from the budgeted capital projects 214 of FIG. 2A to be grouped according to the bucketing rules 216 of FIG. 2A. The bucketing rules 216 can group compatible project locations within X unit distance. The project bucketing 210 generates a combined project for each location group as the bucketed capital projects 218 of FIG. 2A.

At block 258, the optimization model 206 of FIG. 2A is run to generate a new service life extension based on bucketed capital projects 218, called SLEⁱ, which is an example of an optimization parameter 212 of FIG. 2A representing a critical attribute based on at least one uncertainty of the combined projects in the bucketed capital projects 218. At block 260, if SLEⁱ is within a desired range relative to the maximum SLE*, then the process 250 ends at block 262. The desired range may be defined as β*SLE*≧SLEⁱ≧α*SLE*, where 1≧β≧α. If SLEⁱ is within the desired range, process 250 proceeds to block 264.

At block 264, if SLEⁱ is above a tolerable level, then there is a gap for further bucketing; therefore, the diameter of bucketing for grouping locations is increased at block 266 and the process 250 returns to block 256 for further bucketing. A SLEⁱ value that is better than a tolerable level can be defined as SLEⁱ>β*SLE*. If SLEⁱ is not above a tolerable level, then at block 268, the diameter of bucketing is decreased and the process 250 returns to block 256 for further bucketing.

In an exemplary embodiment, the process 250 seeks to fund the best projects to achieve highest level of service life extension, within multi-layer budget constraints. The process 250 is stochastic due to incomplete information and uncertainty of the treatment options that would be required for each asset, which impacts the SLEⁱ value. Some of the sources of uncertainty are difficulty of investigating the assets, multi-year planning, and incomplete asset health information. The status of certain assets, such as sanitary pipes, water pipes, and utilities that are located underground may be difficult to investigate and therefore complete information is not available for planning. Planning over multi-year periods, such as 3 to 5 years out results in uncertainty about assets condition in the future. Due to size of a city and varying ages of the assets, there may be missing information (e.g., construction year, material used etc. . . . ) about the assets making it difficult to prescribe the correct treatment option. The optimization model 206 of FIG. 2A attempts to constrain a number of uncertainties based on various inputs and optimization parameters 212 of FIG. 2A.

Example input data to the optimization model 206 of FIG. 2A are provided in Table 1.

TABLE 1
Optimization Model Input Data Sets
Input Data Sets

| Set Name - Set Short Name | Set Fields | Description |
|---|---|---|
| ST_Execution_Parameters - | | Tuple set containing |
| EP | | execution parameters |
| | Scenario_Id | Execution scenario |
| | Allow_Funding_Overrun | (0, 1) - Flag to allow |
| | | funding usage above the |
| | | limit |
| | Include_Exclude | (0, 1) - Flag to force |
| | | project include/exclude |
| | | requirement |
| | Maximize_RSL | (0, 1) - Flag to enable |
| | | maximizing remaining |
| | | service life as an objective |
| | Planning_Horizon_Start | Planning horizon start |
| | | year |
| | Planning_Horizon_End | Planning horizon end year |
| | Allow_Carry_Over | (0, 1) - Flag to allow |
| | | projects to be considered |
| | | at the future planning |
| | | periods (out of designated |
| | | project_year) |
| | Use_Prefered_Funding | (0, 1) - Flag to force using |
| | | preferred funding for the |
| | | designated projects |
| ST_Funding_x_Asset_Class - | | Tuple set containing |
| FA | | funding type to asset |
| | | class mapping |
| | Funding_Type | Funding types, such as gas |
| | | tax, development charges, |
| | | water tax and so on |
| | Asset_Class | Asset classes, such as |
| | | road, sanitary pipe, water |
| | | pipe and so on |
| ST_Funding_x_Driver - FD | | Tuple set containing |
| | | funding type to asset |
| | | prescription driver |
| | | mapping |
| | Funding_Type | Funding types, such as gas |
| | | tax, development charges, |
| | | water tax and so on |
| | Driver | Asset prescription driver, |
| | | such as condition, |
| | | capacity, risk and so on |
| ST_Funding_x_Project_Class - | | Tuple set containing |
| FP | | funding type to project |
| | | class mapping |
| | Funding_Type | Funding types, such as gas |
| | | tax, development charges, |
| | | water tax and so on |
| | Project_Class | Project classes, such as |
| | | replacement, |
| | | rehabilitation and so on |
| ST_Treatment_x_Asset_Class - | | Tuple set containing |
| TA | | treatment details for |
| | | asset classes. |
| | Scenario_Id | Execution scenario |
| | Asset_Class | Asset classes, such as |
| | | road, sanitary pipe, water |
| | | pipe and so on |
| | Treatment | Asset treatment types, |
| | | such as full depth and |
| | | reconstruction, |
| | | resurfacing, pipe |
| | | realigning and so on |
| | Service_Life_Extension | Asset service life |
| | | extension for the given |
| | | treatment option |
| | Service_Level_Improvement | Asset service level |
| | | (qualitative) improvement |
| | | for the given treatment |
| | | option |
| | Unit | Unit of the asset, such a |
| | | meter, meter square and |
| | | so on |
| | Unit_Cost | Cost of treatment per unit |
| | | asset |
| ST_Project - P | | Tuple set containing |
| | | project details |
| | Scenario_Id | Execution scenario |
| | Project_Id | Unique project |
| | | identification number |
| | Project_Year | Designated project year |
| | Include_Exclude | Flag (‘yes’/‘no’) to force |
| | | project to be included or |
| | | excluded in the plan |
| ST_Location - L | | Tuple set containing |
| | | project location details |
| | | (one project may contain |
| | | multiple locations) |
| | Scenario_Id | Execution scenario |
| | Project_Id | Unique project |
| | | identification number |
| | Project_Year | Designated project year |
| | Location_Id | Unique location |
| | | identification number |
| | Preferred_Funding_Source | Preferred funding source |
| | | for the project at this |
| | | location |
| | Project_Class | Project classes, such as |
| | | replacement, |
| | | rehabilitation and so on |
| ST_Asset - A | | Tuple set containing asset |
| | | details (one location may |
| | | contain multiple assets). |
| | | Note that treatment |
| | | requirement is uncertain, |
| | | and uncertainty is |
| | | captured by |
| | | Treatment_Probability. |
| | Scenario_Id | Execution scenario |
| | Project_Id | Unique project |
| | | identification number |
| | Project_Year | Designated project year |
| | Location_Id | Unique location |
| | | identification number |
| | Asset_Class | Asset classes, such as |
| | | road, sanitary pipe, water |
| | | pipe and so on |
| | Asset_Quantity | Asset quantity, such as |
| | | area of road segment, or |
| | | length of pipe |
| | Asset_Health_Score | Asset health score (to be |
| | | used while making |
| | | investment decisions) |
| | Asset_Age | Asset age (to be used |
| | | while calculating asset |
| | | service life extention) |
| | Driver | Asset prescription driver, |
| | | such as condition, |
| | | capacity, risk and so on |
| | Treatment | Asset treatment |
| | | requirement, such as full |
| | | depth and reconstruction, |
| | | resurfacing, pipe |
| | | realigning and so on |
| | Treatment Probability | Probability of a certain |
| | | treatment being required |
| | | for this asset (uncertainty) |
| ST_Funding - F | | Tuple set containing the |
| | | funding availability |
| | Scenario_Id | Execution scenario |
| | Funding_Type | Funding types, such as gas |
| | | tax, development charges, |
| | | water tax and so on |
| | Availability_Year | Funding availability year |
| | Amount_Available | Available funding amount |

Table 2 defines an example of calculated datasets to use in the optimization model 206 of FIG. 2A. Tuples can be formed, for example, by combining the project funding mapping 222 of FIG. 2A with project-location-asset attributes.

TABLE 2
Optimization Model Calculated Datasets
Calculated Data Sets

| Set Name - Set Short Name | Set Fields | Description |
|---|---|---|
| ST_Funding_Mapping - | | Set of tuple containing the |
| FM | | funding mapping between each |
| | | project-location-asset group to |
| | | funding type. This dataset is |
| | | calculated by combining funding |
| | | mapping datasets |
| | | (ST_Funding_x_Asset_Class, |
| | | ST_Funding_x_Driver, |
| | | ST_Funding_x_Project_Class) |
| | | and comparing these with |
| | | project-location-asset |
| | | attributes, as: |
| | | FA.Asset_Class = A.Asset_Class, |
| | | FD.Driver = A.Driver, |
| | | FP.Project_Class = L.Project_Class |
| | Project_Id | Unique project identification |
| | | number |
| | Location_Id | Unique location identification |
| | | number |
| | Asset_Class | Asset classes, such as road, |
| | | sanitary pipe, water pipe and |
| | | so on |
| | Funding_Type | Funding types, such as gas tax, |
| | | development charges, water tax |
| | | and so on |
| | Prefered_Funding_Source | If EP.Use_Prefered_Funding = 1, |
| | | then this field gets the value of |
| | | L.Preferred_Funding_Source, |
| | | else the field value is same as |
| | | Funding_Type |
| S_Planning_Horizon - T | | Set containing the time bucket |
| | | information, calculated as |
| | | EP.Planning_Horizon_Start ≦ t ≦ |
| | | EP.Planning_Horizon_End |

A number of decision variables may be defined by the optimization model 206 of FIG. 2A to perform optimization. Examples of the decision variables include:
V_ProjectFunded_{p,t} ∀p [symbol] P, t [symbol] T
Binary (0, 1) decision variables indexed over ST_Project and S_Planning_Horizon.
Gets value 1 if project p is funded at time t, and 0 otherwise.
   V_LocationFunded_{l,t} ∀l [symbol] L, t [symbol] T
Binary (0, 1) decision variables indexed over ST_Location and S_Planning_Horizon.
Gets value 1 if location l is funded at time t, and 0 otherwise.
   V_AssetFunded_{a,t} ∀a [symbol] A, t [symbol] T
Binary (0, 1) decision variables indexed over ST_Asset and S_Planning_Horizon.
Gets value 1 if asset a is funded at time t, and 0 otherwise.
   V_Funding_{fm,t}^{s} ∀fm [symbol] FM, t [symbol] T, s [symbol] S
Stochastic decision variables indexed over ST_Funding_Mapping and S_Planning_Horizon.
For each stochastic programming scenario s, captures the funding amount allocated to project-location-asset (p, l, a) group from funding type f at time t.
   V_FundingAddition_{f} ∀f [symbol] F
Decision variable indexed over ST_Funding.
Captures additional funding requirement (on top of availability) due to project Include/Exclude requirements (active if EP.Include_Exclude=1).
   V_FundingOverrun_{f} ∀f [symbol] F
Decision variable indexed over ST_Funding.
Captures additional funding requirement (on top of availability) to fund all existing projects if budget constraints are relaxed (active if EP.Allow_Funding_Overrun=1).

The optimization model 206 of FIG. 2A can be defined as a series equations to be maximized subject to a number of constraints. In an exemplary embodiment, the optimization model 206 is defined as:

$$\begin{matrix} Equation \text{/} Constraint & No . \\ maximize {w}_{1} * {\sum }_{p ∈ P , t ∈ T} {V\_ProjectFunded}_{p , t} & 1.1 \\ + {w}_{2} * {\sum }_{s ∈ S} {p}^{s} {\sum }_{a ∈ A , t ∈ T} Service\_Life {\_Extension}_{a}^{s} * a \cdot Asset\_Quantity * {V\_AssetFunded}_{a , t} & 1.2 \\ - {w}_{3} * {\sum }_{f ∈ F} EP \cdot Include\_Exclude * {V\_FundingAddition}_{f} & 1.3 \\ - {w}_{4} * {\sum }_{f ∈ F} EP \cdot Allow\_Funding \_Overrun * {V\_FundingOverrun}_{f} \\ subject to & 1.4 \\ {\sum }_{t ∈ T} {V\_ProjectFunded}_{p , t} = 0 , \\ ∀ p ∈ P : t \neq p \cdot Project\_Year , EP \cdot Allow\_Carry \_Over = 0 & 2 \\ {\sum }_{t ∈ T} {V\_ProjectFunded}_{p , t} \leq 1 , \\ ∀ p ∈ P : t \geq p \cdot Project\_Year , EP \cdot Allow\_Carry \_Over = 1 & 3 \\ {\sum }_{t ∈ T} {V\_ProjectFunded}_{p , t} = 0 ; \\ ∀ p ∈ P : t < p \cdot Project\_Year , EP \cdot Allow\_Carry \_Over = 1 & 4 \\ {V\_ProjectFunded}_{p , t} = {V\_LocationFunded}_{l , t} , \\ ∀ p ∈ P , l ∈ L , t ∈ T : p \cdot Project\_Id = l \cdot Project\_Id , p \cdot Project\_Year = l \cdot Project\_Year & 5 \\ {V\_LocationFunded}_{l , t} = {V\_AssetFunded}_{a , t} , \\ ∀ l ∈ L , a ∈ A , t ∈ T : l \cdot Project\_Id = a \cdot Project\_Id , l \cdot Location\_Id = a \cdot Location\_Id , \\ l \cdot Project\_Year = a \cdot Project\_Year & 6 \\ {V\_ProjectFunded}_{p , t} = 1 , \\ ∀ p ∈ P , t ∈ T : EP \cdot Include\_Exclude = 1 , p \cdot Include\_Exclude = {}_{}^{′}{yes}{}_{}^{′} , p \cdot Project\_Year = t & 7 \\ {V\_ProjectFunded}_{p , t} = 0 , \\ ∀ p ∈ P , t ∈ T : EP \cdot Include\_Exclude = 1 , p \cdot Include\_Exclude = {}_{}^{′}{no}{}_{}^{′} , p \cdot Project\_Year = t & 8 \\ {Cost}_{a}^{s} * {V\_AssetFunded}_{a , t} = {\sum }_{{{{fm ∈ FM}_{: a \cdot Project\_Id = fm \cdot Project\_Id ,}}_{a \cdot Location\_Id = fm \cdot Location\_Id ,}}_{aAsset\_Class = fm \cdot Asset\_Class}} {V\_Funding}_{fm , t}^{s} , \\ ∀ a ∈ A , t ∈ T , s ∈ S & 9 \\ f \cdot Amount\_Available + EP \cdot Include\_Exclude * {V\_FundingAddition}_{f} + EP \cdot Allow\_Funding \_Overrun * {V\_FundingOverrun}_{f} \geq {\sum }_{{fm ∈ FM :}_{f \cdot Funding\_Type = fm \cdot Funding\_Type}} {V\_Funding}_{sm , t}^{s} , \\ ∀ f ∈ F , t ∈ T , s ∈ S : f \cdot Availability\_Year = t & 10\end{matrix}$$

Equations 1.1-1.4 contain a weighted objective function of the optimization model as maximizing the number of funded projects (1.1), maximizing the service life extension (1.2), minimizing the additional (excess) funding due to mandatory projects when Include_Exclude flag is set to 1, and minimizing the additional (excess) funding if funding constraints are relaxed when Allow_Funding_Overrun flag is set to 1. Maximizing the service life extension captures the stochastic service life extension. The parameters Service_Life_Extension_{α}^{s} are calculated for each asset for each stochastic programming scenario.

In multi-year planning settings, constraints 2-4 guarantee that projects cannot be funded out of their designated Project_Year if Allow_Carry_Over flag is set to 0 (equation 2). Projects can be carried to the future planning years if Allow_Carry_Over flag is set to 1 (equation 3) but cannot be carried to the past planning years (no advancement) if (equation 4). Constraints 5-6 guarantee that if any project is funded, then all locations belonging to parent project (equation 5) and all assets belonging to parent location (equation 6) are completely funded. Constraints 7 forces the projects with include requirements (p.Include_Exclude=‘yes’) to be funded, and constraints 8 forces the projects with exclude requirements (p.Include_Exclude=‘no’) to be not funded, when Include_Exclude flag is set to 1. Constraints 9 are the stochastic funding constraints, making sure that for each stochastic programming scenario, projects (at asset level) are only funded through allowed funding types (funding mapping), and total asset treatment cost is funded completely. The parameters Cost_{α}^{s} capture the treatment cost (calculated from cost of treatment for that stochastic programming scenario and asset quantity) for each asset for stochastic programming scenario s. Constraints 10 are the budget constraints, limiting total funding to be within available funding and allowed funding extensions (due to mandatory projects or relaxed budget).

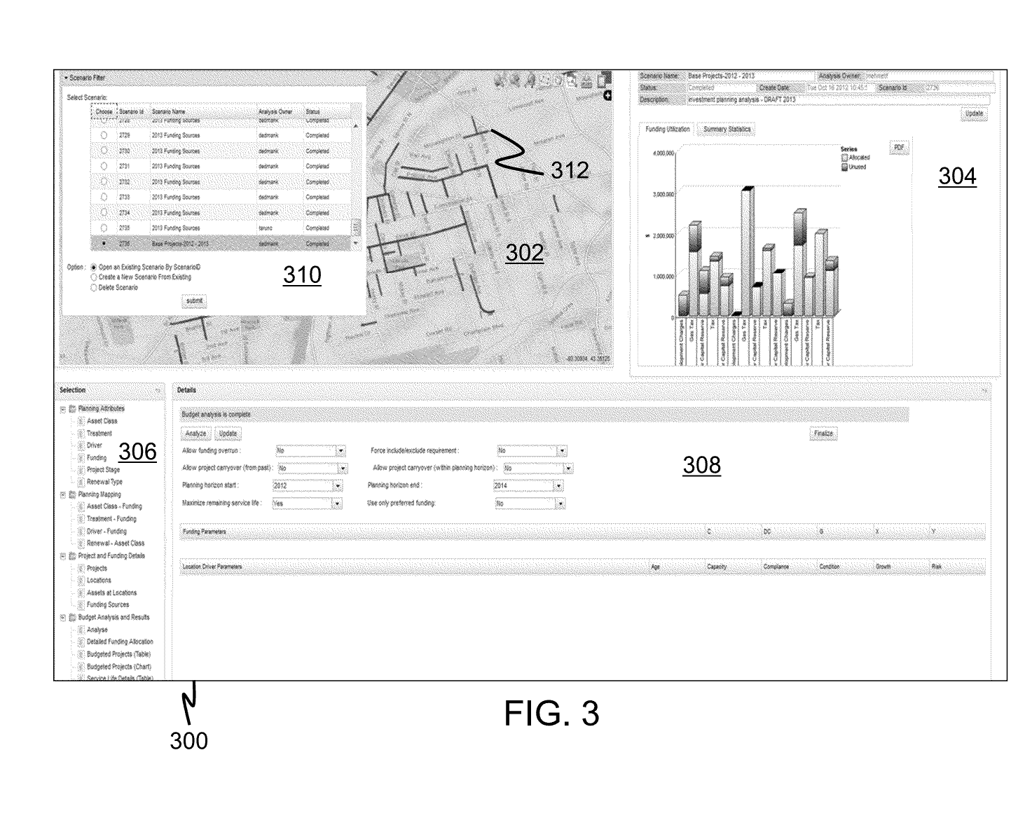

FIG. 3 depicts a user interface 300 of a stochastic investment planning system in accordance with an embodiment. The example user interface 300 of FIG. 3 includes a map view 302, a funding scenario view 304, a navigation view 306, and a detail display view 308. The map view 302 can present capital planning candidate projects across all asset classes. A scenario selection sub-view 310 of the map view 302 can be used to select from a number of possible execution scenarios for analysis, display, and modification. Once the budgeted projects for an execution scenario are identified, the map view 302 can present additional map layers corresponding to the selected projects. For example, in the map view 302 of FIG. 3, a number of street segments 312 are highlighted to illustrate a spatial impact for a selected execution scenario.

The funding scenario view 304 presents a high level funding allocation/utilization and summary statistics associated with the selected execution scenario. The funding scenario view 304 can include scenario information, such as a current scenario ID, scenario name, analysis owner, status, creation date and description. The funding scenario view 304 may also display funding utilization, which presents the results of the budget funding utilization. In this example of the funding scenario view 304, the x-axis presents a detailed breakdown of funding sources by funding year, and the y-axis presents funding allocation. One bar portion in the funding scenario view 304 can be used to indicate allocated funding and a second bar portion indicates unused funding. Bar portions of the funding scenario view 304 can be color coded to provide information, such as a negative red bar indicating a deficit (i.e., additional funding is needed) for budgeted projects. Negative funding can be a result of ‘must do’ projects or ‘allow funding overrun’ scenarios. Clicking on any of the bars of the funding scenario view 304 may show additional details for the project. The funding scenario view 304 may also display summary statistics as a table to provide a before vs. after comparison. The comparison is done with respect to the projects selected during the budgeting process.

The navigation window 306 can be used to support the entire investment planning process, with associated details displayed in the detail display view 308. Clicking on any node or child node in the navigation window 306 can result in corresponding information, such as input data, output data and analysis parameter data being displayed in the detail display view 308. Using the navigation window 306, a list of projects can be accessed, that may include rows representing a project having an identifier, a name, and an expected project year. Users can force the project to be included into the budget. Alternatively, project selection can be based on selecting projects to be removed from consideration. Once the capital plan is finalized, a capital allocation year column can show the budgeted year.

Each project can have one or more locations. A location view selected via the navigation window 306 can present the detailed location information for each project in the detail display view 308. A driver and treatment type for each location can also be tracked.

Selection of a Project and Funding Details—Assets at Locations from the navigation window 306 can provide a detailed breakdown of assets in the location. For each asset, the detail display view 308 can be updated to list an asset class, cost and quantity, renewal type, current service life and condition index.

Selection of Budget Analysis and Results—Analyze node from the navigation window 306 can enable a user to perform budget analysis. The detail display view 308 of FIG. 3 depicts an example interface when this option is selected. Multiple options for analysis are provided, such as allowing a funding overrun. When allowing a funding overrun, this enables running an optimization instance by the optimization model 206 of FIG. 2A without applying the budget constraints. If this option is set to ‘Yes’ the system will not take the budget funding amounts into account. Not applying budget amounts enables the optimization model 206 to select all projects. This also enables the user to identify a budget shortfall to execute all projects.

Another option is to force include/exclude requirements, which forces projects to be included/excluded. This option applies to the user assignment on a projects tab. A further option is to allow project carryover (from past). If this flag is set to ‘Yes’, projects from the past year (before the planning horizon start) will be considered as potential candidates in the budgeting process. Another option is to allow project carryover (within planning horizon). If this flag is set to ‘Yes’, projects within the planning horizon will be considered as candidates for future years within the planning horizon. For example, if a project is assigned to year 2014 as a potential date, and the planning horizon is 2013-2016, this project will be considered as a candidate for 2015 and 2016. If this option is set to ‘No’, a project will only be considered for the assigned year.

The example detail display view 308 depicted in FIG. 3 also includes an Analyze button to kick off the budget optimization process by the optimization model 206 of FIG. 2A. If any of the parameters are changed, the analyze function may only take changes into consideration if an update has been requested using an Update button. By clicking on the Update button, input parameters can be updated to run the optimization model 206 of FIG. 2A. A Finalize button may also be provided to copy back capital budgets to the projects by capital allocation year. This finalizes the execution scenario such that no further changes can take effect.

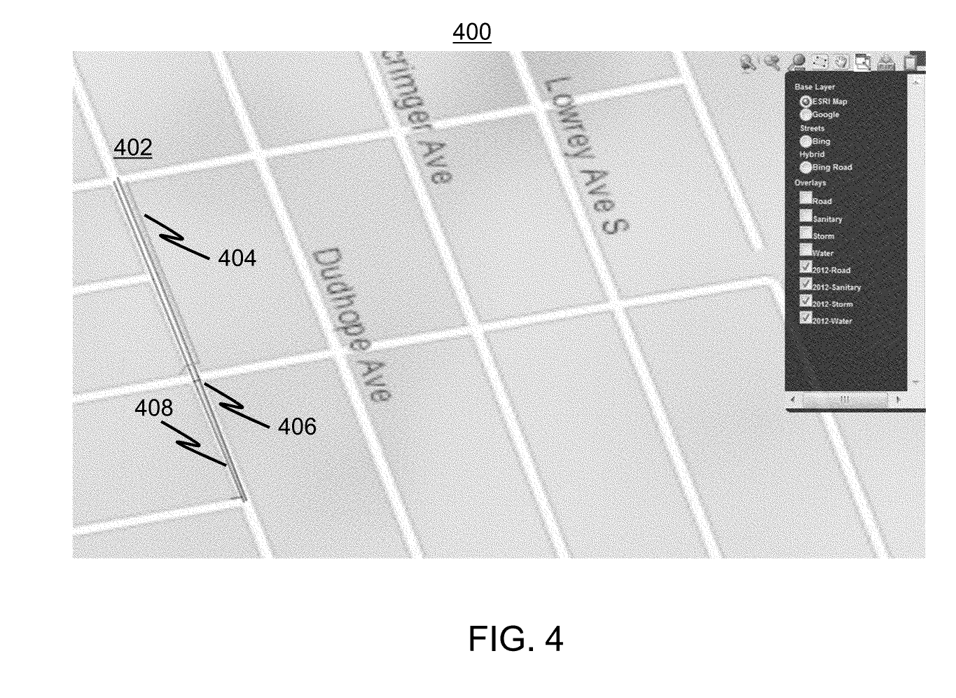

FIG. 4 depicts a layered map view 400 of a stochastic investment planning system in accordance with an embodiment. The layered map view 400 is an example of the map view 302 of FIG. 3, where a plurality of layers associated with different agencies can be overlaid for planning and visualization. The layered map view 400 in the example of FIG. 4 depicts a region of spatial overlap 402, where projects to be performed by a plurality of agencies will be working with at least partial overlap for street segments. In this example, a water department project 404, a sanitary department project 406, and a storm drain project 408 can all be coordinated as part of a common bucket or combined capital project for one or more road segments in order to avoid re-digging the same road multiple times around a common point in time.

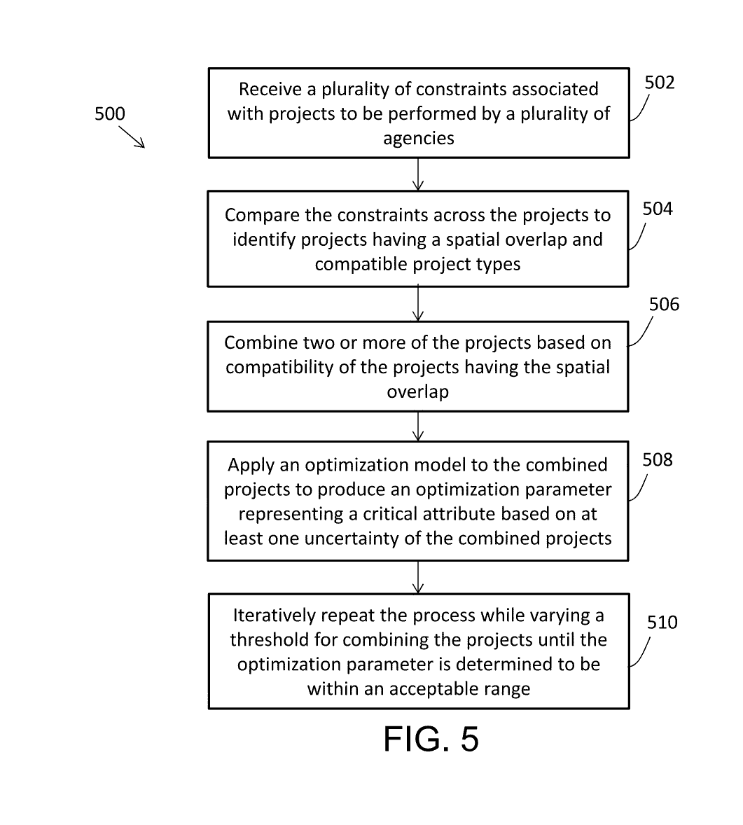

FIG. 5 depicts a process 500 for stochastic investment planning in accordance with an embodiment. At block 502, a plurality of constraints associated with projects to be performed by a plurality of agencies are received. The constraints may include, for example, two or more of: total funding, funding by project type, funding by asset class, funding by performance driver, minimum service life extension expected, spatial correlation, spatial proximity, and spatial overlap. Project budgeting may be performed based on identified capital needs, predefined projects, funding sources, and project funding mapping to produce budgeted capital projects. An initial iteration of the process 500 may allocate a single project per location. At block 504, constraints are compared across the projects to identify projects having a spatial overlap and compatible project types. At block 506, two or more of the projects are combined based on compatibility of the projects having the spatial overlap. Multiyear project planning can be supported when combining the projects.

At block 508, an optimization model is applied to the combined projects to produce an optimization parameter representing a critical attribute based on at least one uncertainty of the combined projects. The optimization parameter may be a service life extension based on service life extension values calculated for each asset in the combined projects. The uncertainty can relate to one or more aspects of the underlying assets of the projects, such as asset condition, remaining life, etc. The optimization model can include maximizing the service life extension in combination with a number of funded projects, while selectively minimizing additional funding due to mandatory projects and selectively minimizing additional funding based on allowed funding overruns. Constraints or rules applied by the optimization model can include guaranteeing for any project that is funded, all locations belonging to a parent project and all assets belonging to a parent location are completely funded, and ensuring that for each scenario, the projects are only funded at an asset level through allowed funding types according to funding mapping, and a total asset treatment cost is funded completely.

At block 510, the process is iteratively repeated while varying a threshold for combining the projects until the optimization parameter is determined to be within an acceptable range. The combined projects can be output as bucketed capital projects. The user interface 300 of FIG. 3 can be used to interactively display the combined projects and highlight spatial alignment between the projects and the agencies.

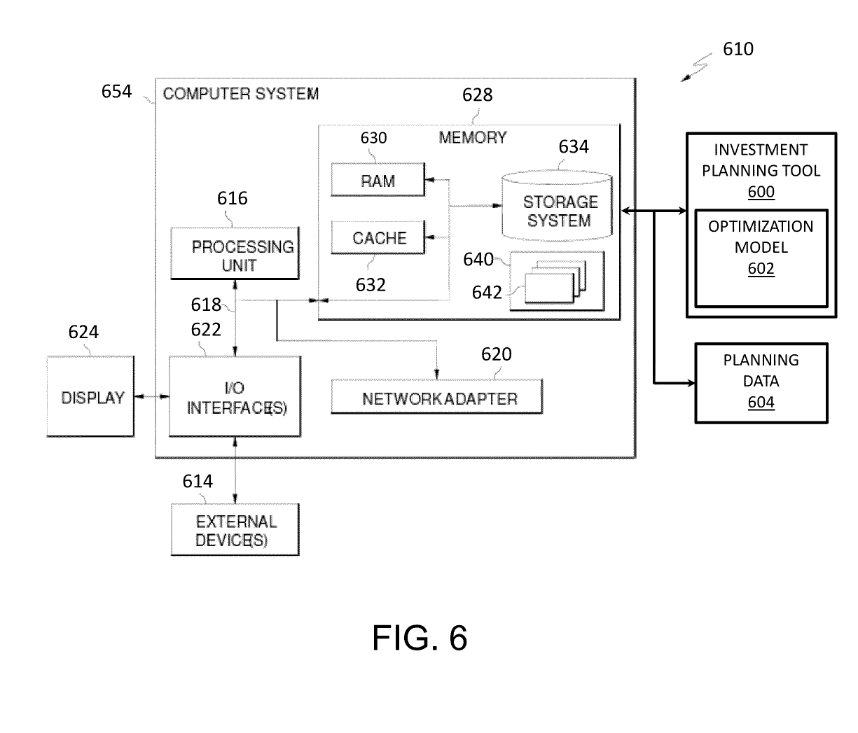

Referring now to FIG. 6, a schematic of an example of a computer system 654 in an environment 610 is shown. The computer system 654 is only one example of a suitable computer system and is not intended to suggest any limitation as to the scope of use or functionality of embodiments described herein. Regardless, computer system 654 is capable of being implemented and/or performing any of the functionality set forth hereinabove.

In the environment 610, the computer system 654 is operational with numerous other general purpose or special purpose computing systems or configurations. Examples of well-known computing systems, environments, and/or configurations that may be suitable as embodiments of the computer system 654 include, but are not limited to, personal computer systems, server computer systems, cellular telephones, thin clients, thick clients, hand-held or laptop devices, multiprocessor systems, microprocessor-based systems, set top boxes, programmable consumer electronics, network personal computer (PCs), minicomputer systems, mainframe computer systems, and distributed cloud computing environments that include any of the above systems or devices, and the like.

Computer system 654 may be described in the general context of computer system-executable instructions, such as program modules, being executed by one or more processors of the computer system 654. Generally, program modules may include routines, programs, objects, components, logic, data structures, and so on that perform particular tasks or implement particular abstract data types. Computer system 654 may be practiced in distributed computing environments, such as cloud computing environments, where tasks are performed by remote processing devices that are linked through a communications network. In a distributed computing environment, program modules may be located in both local and remote computer system storage media including memory storage devices.

As shown in FIG. 6, computer system 654 is shown in the form of a general-purpose computing device. The components of computer system 654 may include, but are not limited to, one or more computer processing circuits (e.g., processors) or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 654 typically includes a variety of computer system readable media. Such media may be any available media that is accessible by computer system 654, and it includes both volatile and non-volatile media, removable and non-removable media.

System memory 628 can include computer system readable media in the form of volatile memory, such as random access memory (RAM) 630 and/or cache memory 632. Computer system 654 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 642, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein. An example application program or module is depicted in FIG. 6 as investment planning tool 600, including optimization model 602 which includes logic that is configured to optimize planning data 604 for a plurality of constraints. The optimization model 602 represents an embodiment of the optimization model 206 in FIG. 2A within the context of the computer system 654. Although the optimization model 602 is depicted within investment planning tool 600, all or portions of the optimization model 602 can be incorporated in any application or module, such as a file navigation tool. The planning data 604 can include various drivers, constraints, and optimization parameters as previously described to support the investment planning tool 600. The planning data 604 can be stored in storage system 634 or in other portions of system memory 628. Alternatively, the planning data 604 may be stored elsewhere in the environment 610. The planning data 604 is used herein as one example of a location where the planning data may be stored, it is not intended to imply that a database system is required as the planning data may be stored in any manner that allows types of accesses described herein.

Computer system 654 may also communicate with one or more external devices 614 such as a keyboard, a pointing device, a display device 624, etc.; one or more devices that enable a user to interact with computer system 654; and/or any devices (e.g., network card, modem, etc.) that enable computer system 654 to communicate with one or more other computing devices. Such communication can occur via input/output (I/O) interfaces 622. Still yet, computer system 654 can communicate with one or more networks such as a local area network (LAN), a general wide area network (WAN), and/or a public network (e.g., the Internet) via network adapter 620. As depicted, network adapter 620 communicates with the other components of computer system 654 via bus 618. It should be understood that although not shown, other hardware and/or software components could be used in conjunction with computer system 654. Examples, include, but are not limited to: microcode, device drivers, redundant processing units, external disk drive arrays, redundant array of independent disk (RAID) systems, tape drives, and data archival storage systems, etc.

It is understood in advance that although this disclosure includes a detailed description on a particular computing environment, implementation of the teachings recited herein are not limited to the depicted computing environment. Rather, embodiments are capable of being implemented in conjunction with any other type of computing environment now known or later developed (e.g., any client-server model, cloud-computing model, etc.).

Technical effects and benefits include a system that provides a strategic approach to infrastructure asset planning. The system implements a robust optimization approach that ensures solution stability in the presence of uncertain project execution. Spatial correlation prevents street blocks from being dug twice in close time proximity. The system provides multi-agency planning that synchronizes plans from all agencies. The system can also optimize on multiple performance drivers by weighting each driver differently.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1-7. (canceled)

8. A computer program product for stochastic investment planning, the computer program product comprising:
a computer readable storage medium having computer readable program code embodied therewith, said program code being executable by a processor to perform a method comprising:
receiving a plurality of constraints associated with projects to be performed by a plurality of agencies;
comparing the constraints across the projects to identify projects having a spatial overlap and compatible project types;
combining two or more of the projects based on compatibility of the projects having the spatial overlap;
applying an optimization model to the combined projects to produce an optimization parameter representing a critical attribute based on at least one uncertainty of the combined projects; and
iteratively repeating the comparing, the combining, and the applying of the optimization model while varying a threshold for combining the projects until the optimization parameter is determined to be within an acceptable range.

9. The computer program product of claim 8, wherein the optimization parameter is a service life extension based on service life extension values calculated for each asset in the combined projects.

10. The computer program product of claim 8, wherein the constraints comprise performance drivers, and further comprising optimizing the performance drivers by weighting each of the drivers differently.

11. The computer program product of claim 10, further comprising maximizing the service life extension in combination with a number of funded projects, while selectively minimizing additional funding due to mandatory projects and selectively minimizing additional funding based on allowed funding overruns.

12. The computer program product of claim 8, further comprising supporting multiyear project planning when combining the projects.

13. The computer program product of claim 8, further comprising:
guaranteeing for any project that is funded, all locations belonging to a parent project and all assets belonging to a parent location are completely funded; and
ensuring that for each scenario, the projects are only funded at an asset level through allowed funding types according to funding mapping, and a total asset treatment cost is funded completely.

14. The computer program product of claim 8, wherein the constraints include two or more of: total funding, funding by project type, funding by asset class, funding by performance driver, minimum service life extension expected, spatial correlation, spatial proximity, and spatial overlap.

15. A system for stochastic investment planning, the system comprising:
a processor; and
an investment planning tool executable by the processor to perform a method comprising:
receiving a plurality of constraints associated with projects to be performed by a plurality of agencies;
comparing the constraints across the projects to identify projects having a spatial overlap and compatible project types;
combining two or more of the projects based on compatibility of the projects having the spatial overlap;
applying an optimization model to the combined projects to produce an optimization parameter representing a critical attribute based on at least one uncertainty of the combined projects; and
iteratively repeating the comparing, the combining, and the applying of the optimization model while varying a threshold for combining the projects until the optimization parameter is determined to be within an acceptable range.

16. The system of claim 15, wherein the optimization parameter is a service life extension based on service life extension values calculated for each asset in the combined projects and the investment planning tool is further configured to perform:
maximizing the service life extension in combination with a number of funded projects, while selectively minimizing additional funding due to mandatory projects and selectively minimizing additional funding based on allowed funding overruns.

17. The system of claim 15, wherein the investment planning tool is further configured to support multiyear project planning when combining the projects.

18. The system of claim 15, wherein the investment planning tool is further configured to perform:
guaranteeing for any project that is funded, all locations belonging to a parent project and all assets belonging to a parent location are completely funded; and
ensuring that for each scenario, the projects are only funded at an asset level through allowed funding types according to funding mapping, and a total asset treatment cost is funded completely.

19. The system of claim 15, wherein the constraints include two or more of: total funding, funding by project type, funding by asset class, funding by performance driver, minimum service life extension expected, spatial correlation, spatial proximity, and spatial overlap.

20. The system of claim 15, wherein the investment planning tool is further configured to perform:
interactively displaying the combined projects on a user interface to highlight spatial alignment between the projects and the agencies.
